(19) United States
(12) Patent Application Publication
(10) Pub. No.: US 2003/0214972 A1
(43) Pub. Date: Nov. 20, 2003

(54) Method for detecting frame type in home networking

(76) Inventors: Benny J. Pollak, Alon Shevoot (IL); Vladimir Kravtsov, Jerusalem (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/144,780

(22) Filed: May 15, 2002

(51) Int. Cl. H04J 3/22

(52) U.S. Cl. 370/470; 370/445

(57) ABSTRACT

A unit for identification of frame format in a home networking device includes a comparison unit and an identifier. The comparison unit is adapted to compare the energy of a first period with the energy of a later period within the frame. The identifier is adapted to identify the frame format from the results of the comparison. The invention also includes the methods performed by the units.

### FIELD OF THE INVENTION

The present invention relates to home networking protocols generally and to frame formats in such protocols in particular.

### BACKGROUND OF THE INVENTION

There are three kinds of frame formats that are currently used in home networking. The first protocol is the HPNA1 protocol, otherwise known as the legacy protocol, which transfers data at 1 Mb/sec. The second protocol, the HPNA2 or native protocol, transfers data at 10 Mb/s. Since the two protocols are sufficiently different, a station operating in one protocol cannot receive messages in the other protocol. The third protocol is the compatibiilty protocol, which is a combination of the native and the legacy protocols, useful in enabling an HPNA1 station to operate on the same network as an HPNA2 station.

### BRIEF DESCRIPTION OF THE DRAWINGS

The present invention will be understood and appreciated more fully from the following detailed description taken in conjunction with the appended drawings in which:

FIG. 1A is a representation of a data frame in the legacy frame format;

FIG. 1B is a representation of a data frame in the native frame format;

FIG. 1C is a representation of a data frame in the compatibility frame format;

FIG. 2A is a graphical illustration of the energy level in an initial portion of the signal in the legacy frame format;

FIG. 2B is a graphical illustration of the energy level in an initial portion of the signal in the compatibility frame format;

FIG. 3 is a flow chart illustration of the method of the present invention; and

FIG. 4 is a block diagram illustration of a frame identifier, constructed and operative in accordance with a preferred embodiment of the present invention.

### DETAILED DESCRIPTION OF THE PRESENT INVENTION

The methods and apparatus disclosed herein have been described without reference to specific hardware or software. Rather, the methods and apparatus have been described in a manner sufficient to enable persons of ordinary skill in the art to readily adapt commercially available hardware and software as may be needed to reduce any of the embodiments of the present invention to practice without undue experimentation and using conventional techniques.

Reference is now made to FIGS. 1A, 1B and 1C, which illustrate the three types of frame formats, e.g. the legacy, native and compatibility formats, respectively.

As shown in FIG. 1A, the legacy frame format may have a header 10 followed by a data packet 12 (containing the information to be transmitted). The header may have a synchronization interval 14, an access identification (AID) interval 16 followed by a silence interval 18 and a 4 byte PCOM interval 20. As shown in FIG. 1B, the native frame format may have a header, labeled 30, interleaved with the data packet 12, and followed by a postamble 32. Header 30 may begin with a 16 byte preamble 34.

As can be seen from FIGS. 1A and 1B, the legacy and native frame formats are significantly different and a station operating in one protocol may not understand the information sent in another protocol. Moreover, the two protocols may operate at different speeds. The legacy protocol may be a 1 Mbyte/sec protocol while the native protocol may be a 10 Mbyte/sec protocol.

The compatibility frame format may be designed for stations using the native frame formats when sharing a phone line with stations using the legacy frame format. The compatibility frame format may be designed such that the 10 Mbyte/sec transmissions masquerade as valid 1 Mbyte/sec frames for correct carrier sense and collision detection behavior, even though the 1 Mbyte/sec receivers (the legacy stations) may not be able to recover data from the frame.

The compatibility frame format may begin with synchronization interval 14, a modified, 1 Mbyte/sec access ID (AID) interval 40, followed by a silence interval 18. There may follow a 10 Mbyte/sec 48 symbol preamble 42. The rest of the frame is modified to have periodic gaps so that a 1 Mbyte/sec receiver may detect this signal as a series of pulses. The frame may end with a trailer 44.

It is noted that it may be important to distinguish between a legacy frame and a compatibility frame as soon as possible so that the frame may be properly decoded by the relevant station. In accordance with a preferred embodiment of the present invention, this may be done by considering the energy level of the signal during a defined period after AID interval 16 or 40.

Reference is now made to FIGS. 2A and 2B, which illustrate exemplary power shapes for the first few microseconds of the signal, including the AID interval 16 or 40, respectively, and the PCOM interval 20 (of FIG. 1A) or preamble 42 (of FIG. 1C) which follows.

For both signals, the AID interval 16 or 40 may include a number of pulses, typically 7, each of which may be a pulse somewhere within a period T_{A}. Symbols may be differentiated by their position within the period T_{A}. During the AID interval 16 or 40, the receiver may perform automatic gain control to provide a signal with a reasonable signal to noise level. The silence interval 18 may be a period of T_{A} in length.

PCOM interval 20 (FIG. 2A) may comprise 4 bytes (i.e. 16 symbols) spaced a time Tₚ apart.

In contrast and as shown in FIG. 2B, the symbols of preamble 42 may occur at a much higher frequency. Thus, during any period T, more than one pulse may be present.

Reference is now made to FIG. 3, which may illustrate the method of the present invention.

Beginning once the gain level has stabilized (as checked in step 62), the energy during one period T_{A} of the AID interval 40 is accumulated (step 64). This may define the amount of energy in one pulse of the AID interval 40 or 16. In step 66, the accumulated energy may be multiplied by a factor of 4, to produce a total energy value. The system may then wait (step 68) for the end of the silence interval 16.

During the next three periods T_{P}, the energy of the incoming signal may be subtracted (step 70). In step 72, the sign of the signal is checked. If the resultant energy is positive (i.e. there were only a few pulses during the three periods such as occurs during the PCOM interval 20), the data frame may be identified as a legacy frame. If the resultant energy is negative (i.e. there may have been a significant number of pulses during the three periods such as occurs during the preamble 42), the data frame may be identified as a compatibility frame.

It will be appreciated that the present invention may determine the type of frame by comparison to the energy of at least a portion of the AID interval rather than with a fixed threshold.

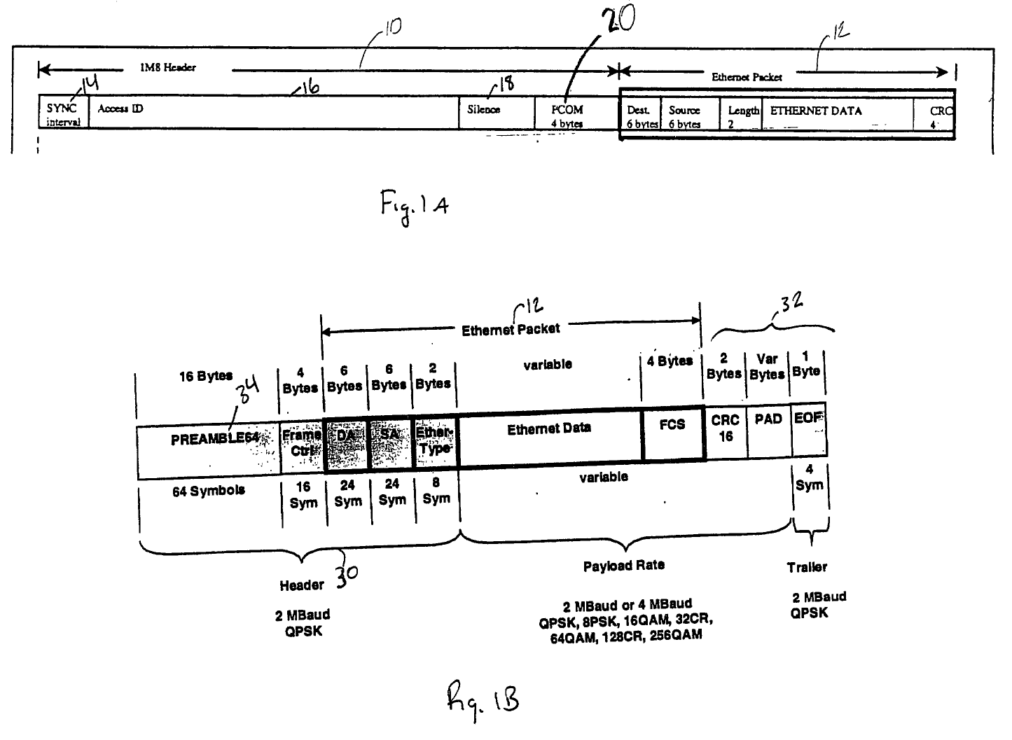

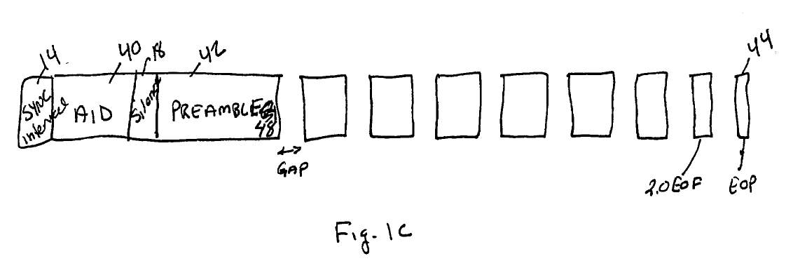

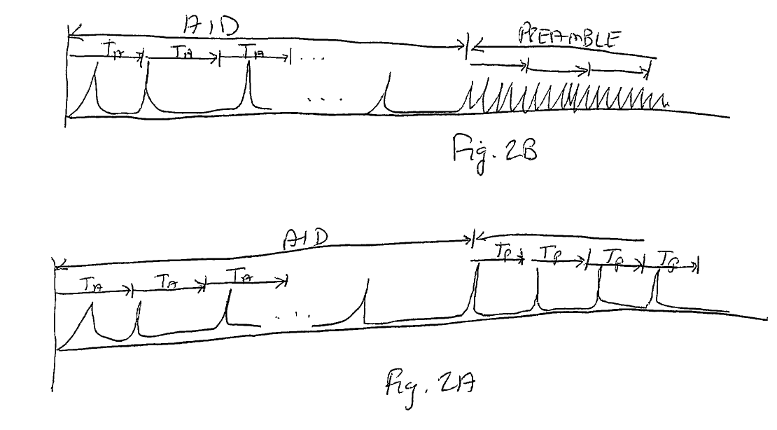

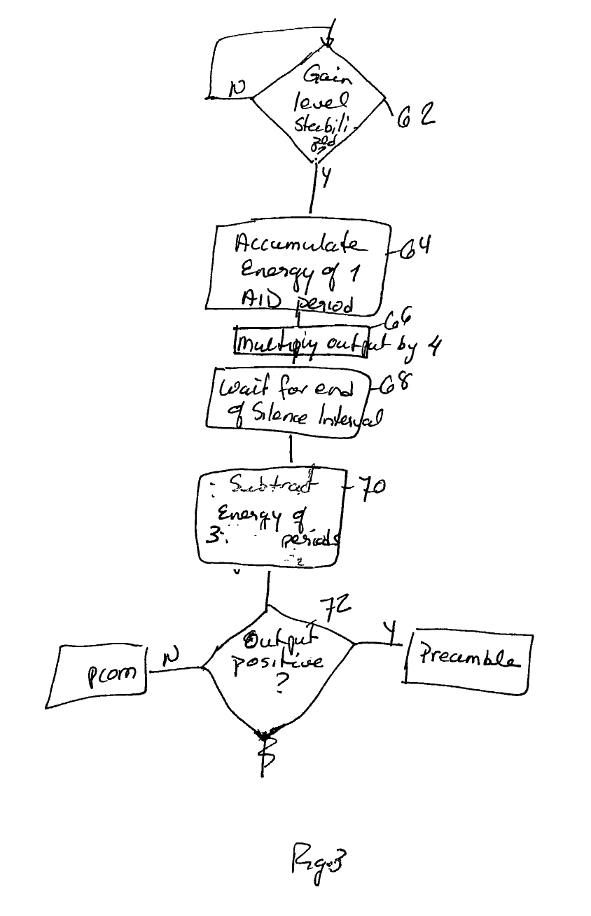

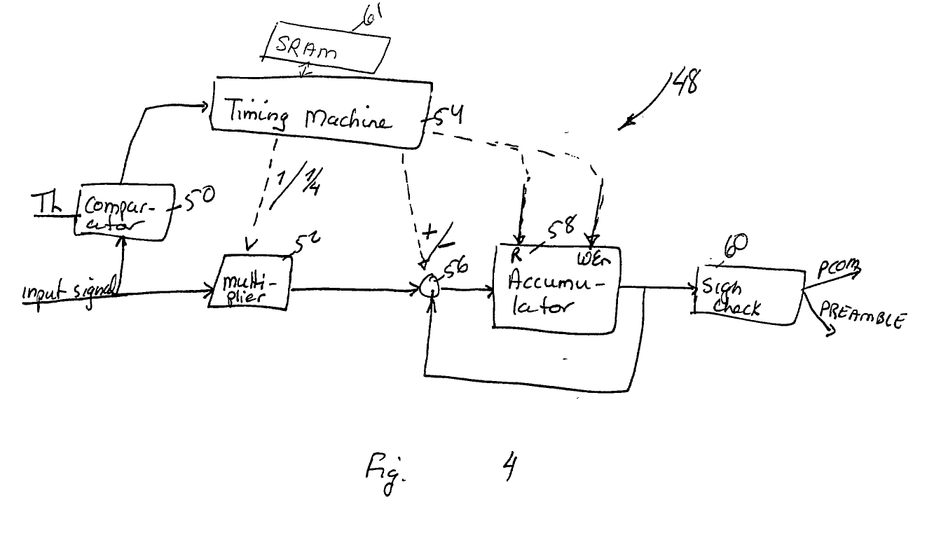

Reference is now made to FIG. 4, which may illustrate a frame identifier 48 that may identify the data frame protocol type. e.g. either a legacy or a compatibility. In FIG. 4 solid lines refer to the movement of data while dashed lines refer to the movement of control signals. The system may comprise a comparator 50, a multiplier 52, a timing machine 54, an adder/subtractor 56, an accumulator 58, a sign check 60 and an SRAM 61.

Comparator 50 may compare the level of the input signal to that of a threshold Th defining when the signal level is high enough to indicate a pulse. Comparator 50 may then provide the pulse indication to timing machine 54 which may then utilize the pulse indication to time the operation of frame identifier 48 as well as provide information for demodulating the data of the frame. The data of the frame is then stored in SRAM 61.

When timing machine 54 may determine that the AID interval 16 or 40 is present (i.e. that the synchronization interval 14 has finished), timing machine 54 may indicate to multiplier 52 to multiply by 1 and to adder/subtractor 56 to perform addition and may activate accumulator 58 by activating its reset R and its write enable WEn inputs. Timing machine 54 may then maintain accumulator 54 active for the length of one period T_{A}. Because adder/subtractor 56 may be adding, accumulator 54 may add the energy in the incoming signal. At the end of the period, timing machine 54 may deactivate the write enable WEn input and accumulator 58 may become inactive.

When timing machine 54 may determine that that AID interval 16 or 40 has finished as has the silence interval 16, timing machine 54 may indicate to multiplier 52 to multiply by 4) and to adder/subtractor 56 to perform subtraction and may reactivate accumulator 58 by activating its write enable WEn input. Accumulator 58

At the end of three periods T_{P}, timing machine 54 may deactivate the write enable WEn input and accumulator 58 may become inactive. Timing machine 54 then indicates to accumulator 58 to output the value stored therein to sign check 60 who may check the sign of the output, identifying the data frame as a legacy frame if the output is positive and as a compatibility frame if the output is negative.

It will be appreciated by persons skilled in the art that the present invention is not limited by what has been particularly shown and described herein above. Rather the scope of the invention is defined by the claims that follow:

1. A method for identification of frame format in a home networking device, the method comprising:
identifying frame formats from the energy within a frame.

2. A method according to claim 1 wherein said identifying comprises:
comparing the energy of a first period with the energy of a later period within said frame; and
identifying said frame format from the results of said comparison.

3. A method according to claim 2 wherein said second identifying comprises identifying a legacy format if said results are positive and identifying a compatibility format if said results are negative.

4. A method according to claim 2 wherein said first period is of generally the length of a pulse and within an access ID (AID) interval and said second period is of generally the length of three pulses and within an interval after said AID interval.

5. A unit for identification of frame format in a home networking device, the unit comprising:
a comparison unit adapted to compare the energy of a first period with the energy of a later period within said frame; and
an identifier adapted to identify said frame format from the results of said comparison.

6. A unit according to claim 5 wherein said identifier comprises a decision unit adapted to identify a legacy format if said results are positive and to identify a compatibility format if said results are negative.

7. A unit according to claim 5 wherein said first period is of generally the length of a pulse and within an access ID (AID) interval and said second period is of generally the length of three pulses and within an interval after said AID interval.

8. A home networking receiver comprising:
a unit adapted to identify frame format in a home networking device, the unit comprising:
a comparison unit adapted to compare the energy of a first period with the energy of a later period within said frame; and
an identifier adapted to identify said frame format from the results of said comparison; and
an SRAM adapted to store data of said frame.

9. A unit according to claim 8 wherein said identifier comprises a decision unit adapted to identify a legacy format if said results are positive and to identify a compatibility format if said results are negative.

10. A unit according to claim 8 wherein said first period is of generally the length of a pulse and within an access ID (AID) interval and said second period is of generally the length of three pulses and within an interval after said AID interval.
